(19) United States
(12) Patent Application Publication
(10) Pub. No.: US 2018/0306360 A1
(43) Pub. Date: Oct. 25, 2018

(54) JOINT FOR CONNECTING A HOSE TO A CHUCK

(71) Applicant: CHUNG-YI KAO, Puyan Township (TW)

(72) Inventor: CHUNG-YI KAO, Puyan Township (TW)

(21) Appl. No.: 15/496,991

(22) Filed: Apr. 25, 2017

(51) Int. Cl. F16L 37/091; F16K 1/14; F16L 33/28

(52) U.S. Cl. CPC F16L 37/0915; F16L 33/28; F16K 1/14

(57) ABSTRACT

A joint includes a sliding collar, a shell, two sealing rings, a valve, a connector and a rod. The sliding collar includes a tunnel in communication with two apertures. The shell extends throughout the tunnel and includes a space in communication with a screw hole and two slots. The sealing rings are inserted in the space. Each of the sealing rings includes an opening in communication with the space. The valve is located between the sealing rings, and includes a channel and a tunnel. The connector includes a threaded portion inserted in the screw hole and a hole in communication with the space. The rod is inserted in the apertures, the slots and the tunnel. Thus, the sliding collar is operable to move the valve between an opening position where the hole is in communication with the openings and a closing position where the hole is blocked from the openings.

### BACKGROUND OF INVENTION

### 1. Field of Invention

The present invention relates to a joint and, more particularly, to a joint for connecting a hose to a chuck.

### 2. Related Prior Art

Water is often used to water plants or wash vehicles for example. In such cases, a hose is often connected to a faucet so that water can be transmitted to a location at a distance from the faucet before it is used for watering or cleaning. Another end of the hose is connected to a sprinkler head for watering or a nozzle for washing. To change replace the sprinkler head with the nozzle, or vice versa, the user has to walk for the distance to reach and operate the faucet to stop water from entering the hose. However, this is troublesome. Moreover, there is always some water left in the hose after the faucet is turned to stop water from entering the hose. Therefore, it is inevitable that some water would run out of the hose when the sprinkler head or nozzle is removed from the hose. Such residual water could wet or contaminate the user's clothing or the environment.

The present invention is therefore intended to obviate or at least alleviate the problems encountered in prior art.

### SUMMARY OF INVENTION

It is the primary objective of the present invention to provide a joint for connecting a hose to a chuck.

To achieve the foregoing objective, the joint includes a sliding collar, a shell, two sealing rings, a valve, a connector and a rod. The sliding collar includes a tunnel in communication with two apertures. The shell extends throughout the tunnel and includes a space in communication with a screw hole and two slots. The sealing rings are inserted in the space. Each of the sealing rings includes an opening in communication with the space. The valve is located between the sealing rings, and includes a channel and a tunnel. The connector includes a threaded portion inserted in the screw hole and a hole in communication with the space. The rod is inserted in the apertures, the slots and the tunnel. Thus, the sliding collar is operable to move the valve between an opening position where the hole is in communication with the openings and a closing position where the hole is blocked from the openings.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a joint according to the preferred embodiment of the present invention;

FIG. 2 is an exploded view of the joint shown in FIG. 1;

FIG. 3 is a further exploded view of the joint shown in FIG. 2;

FIG. 4 is a cross-sectional view of the joint shown in FIG. 1;

FIG. 5 is a cross-sectional view of the joint in another position than shown in FIG. 4;

FIG. 6 is a perspective view of a chuck, a connective tube and the joint shown in FIG. 1;

FIG. 7 is a cross-sectional view of the chuck and the joint depicted in FIG. 6;

FIG. 8 is a cross-sectional view of the chuck and the joint in another position than shown in FIG. 7; and

FIG. 9 is a cross-sectional view of the connective tube and the joint shown in FIG. 6.

### DETAILED DESCRIPTION OF PREFERRED EMBODIMENT

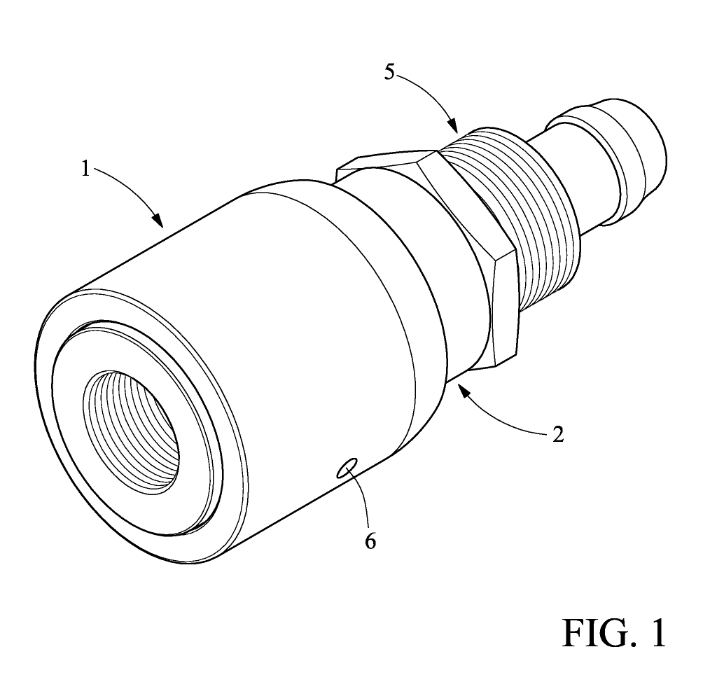

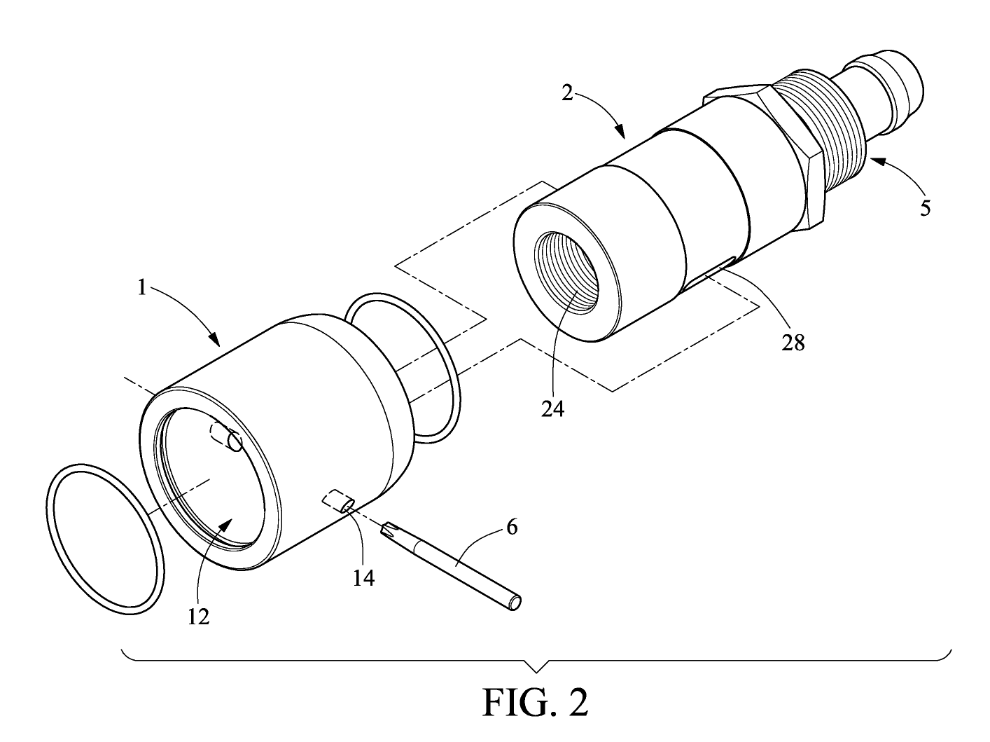

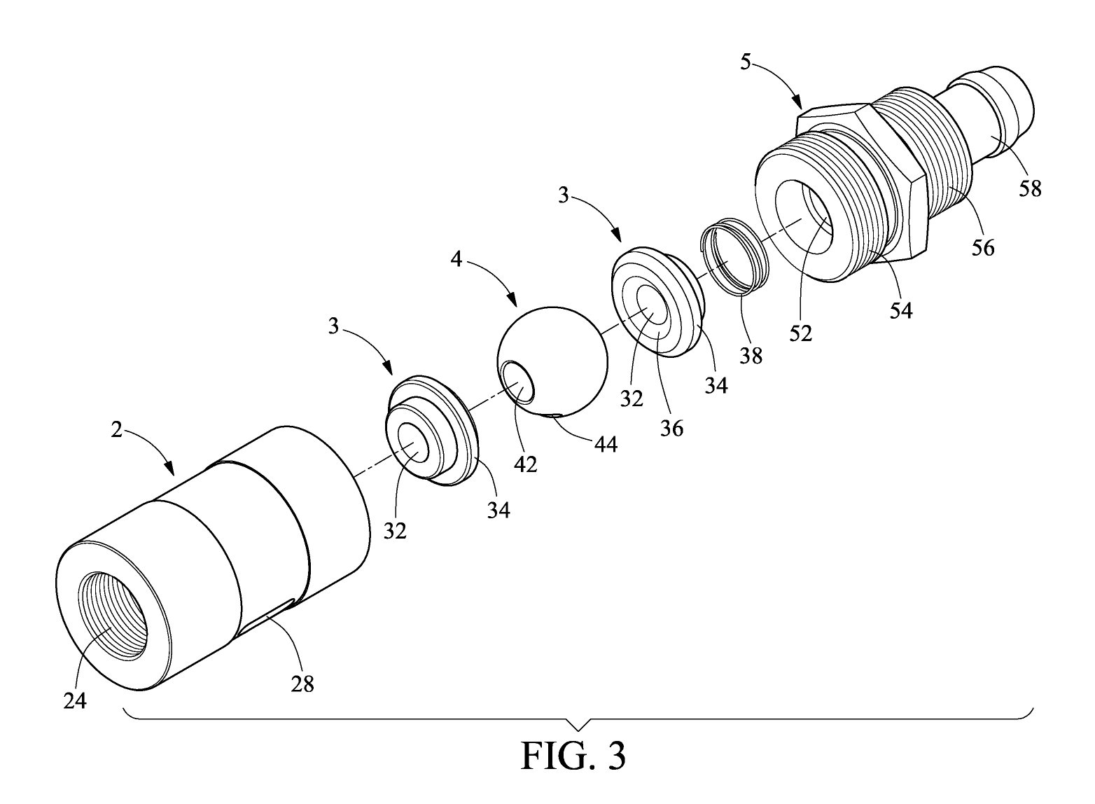

Referring to FIGS. 1 to 5, a joint includes a sliding collar 1, a shell 2, two sealing rings 3, a valve 4, a connector 5, a rod 6 and a spring 38 according to the preferred embodiment of the present invention. The sliding collar 1 includes a tunnel 12 and two apertures 14. The tunnel 12 extends axially throughout the sliding collar 1. The apertures 14 are in communication with the tunnel 12.

The shell 2 includes a space 22, two screw holes 24 and 26 and two slots 28. The screw hole 24 is axially made in an end of the shell 2 while the screw hole 26 is axially made in another end of the shell 2. The space 22 is axially made in the shell 2, between the screw holes 24 and 26. The space 22 is in communication with the screw hole 24 at an end and in communication with the screw hole 26 at another end. Each of the slots 28 extends throughout the shell 2 in a radial manner. Each of the slots 28 extends along an arc on the periphery of the shell 2.

Each of the sealing rings 3 includes an opening 32, an annular flange 34 and a concave face 36. The opening 32 is axially made in each of the sealing rings 3. The annular flange 34 extends on and around the periphery of each of the sealing rings 3. The concave face 36 is formed at an end of each of the sealing rings 3, near the annular flange 34.

The valve 4 is in the form of a sphere that includes a channel 42 and a tunnel 44. The channel 42 extends throughout the valve 4 along a diameter. The tunnel 44 extends throughout a portion of the valve 4. The tunnel 44 is separated from the channel 42.

The connector 5 includes a channel 52, two threaded portion 54 and 56 and an insert 58. The channel 52 axially extends throughout the connector 5. The threaded portion 54 is formed on a portion of the periphery of the connector 5 while the threaded portion 56 is formed on another portion of the periphery of the connector 5. The insert 58 extends from the threaded portion 56. The threaded portion 54 is made in compliance with the screw hole 26. The threaded portion 56 can be omitted if so desired.

In assembly, the valve 4, the sealing rings 3 and the spring 38 are inserted in the space 22 of the shell 2, and the threaded portion 54 is inserted in the screw hole 26. The valve 4 is located between the sealing rings 3, in contact with the concave faces 36. The spring 38 is compressed between the connector 5 and one of the sealing rings 3 to keep the ball 4 in contact with the concave faces 36 of the sealing rings 3. The openings 32 of the sealing rings 3 are in communication with the space 22 of the shell 2. The opening 32 of one of the sealing rings 3 is in communication with the screw hole 24 of the shell 2. The opening 32 of the other sealing ring 3 is in communication with the channel 52 of the connector 5. The shell 2 is inserted in the tunnel 12 of the sliding collar 1. The rod 6 includes a middle section inserted in the tunnel 44, two lateral sections inserted in the slots 28, and two ends inserted in the apertures 14. Thus, the sliding collar 1 is connected to the valve 4 via the rod 6 so that the valve 4 is movable by operating the sliding collar 2. The movement of the sliding collar 1 and the valve 4 is limited to an arched path because the lateral sections of the rod 6 are inserted in the slots 28.

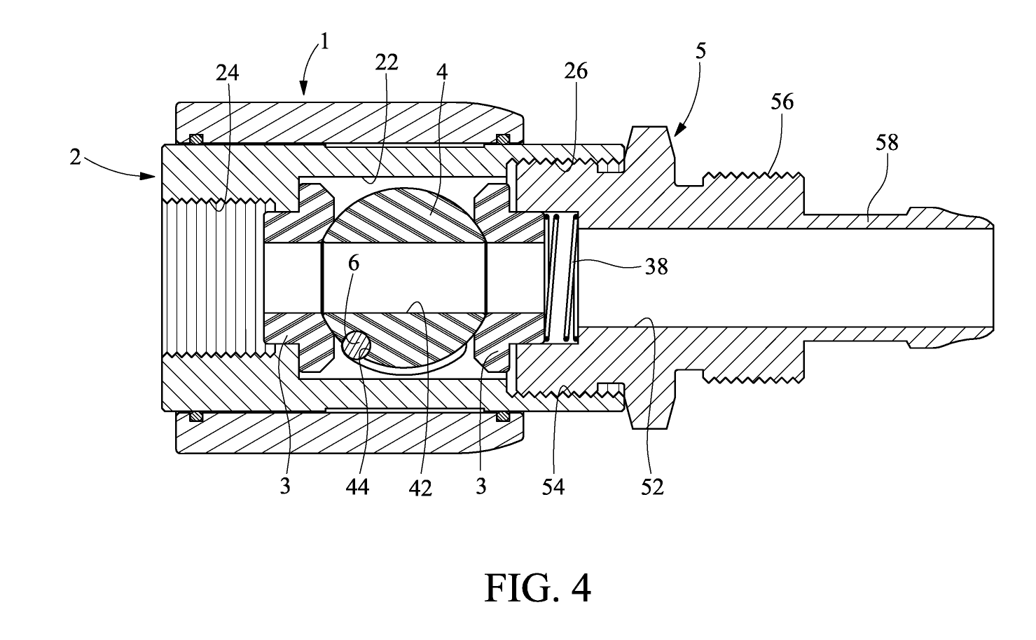

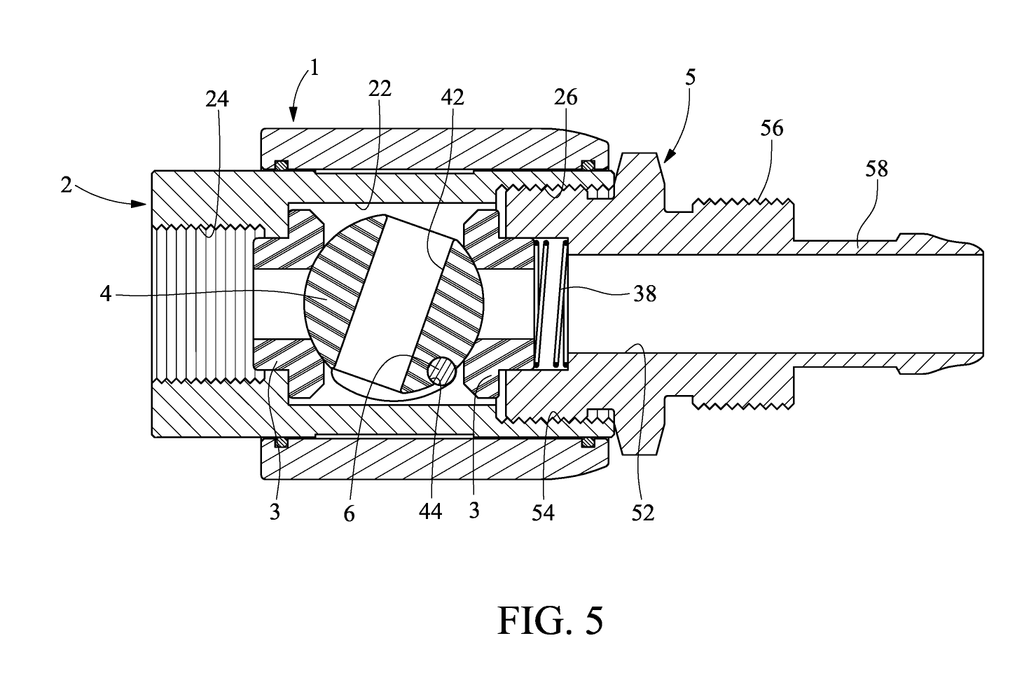

As discussed above, the sliding collar 1 is operable to move the valve 4 between an opening position (FIG. 4) and a closing position (FIG. 5). In the opening position, the tunnel 44 of the sliding collar 4 is in communication with the openings 32 of the sealing rings 3. In the closing position, the tunnel 44 of the sliding collar 4 is not in communication with the opening 32 of any of the sealing rings 3.

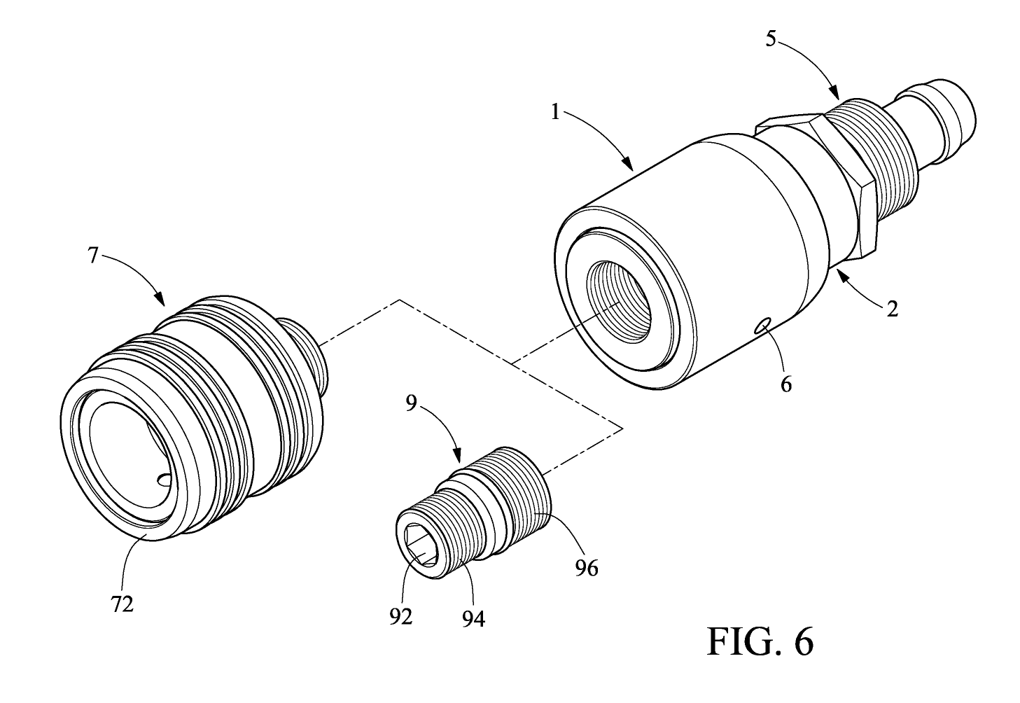

Referring to FIG. 6, the joint can be used with a chuck 7 or a connective tube 9. The chuck 7 is conventional device that includes a switching collar 72 operable to turn the chuck 7 between a locking position and a releasing position.

The connective tube 9 includes a tunnel 92 and two threaded sections 94 and 96. The tunnel 92 axially extends throughout the connective tube 9. The threaded sections 94 and 96 extend on the periphery of the connective tube 9, respectively located near two ends of the connective tube 9.

In operation, the insert 58 of the connector 5 is fitted in an end of a hose (not shown) that includes another end connected to a faucet (not shown). Alternatively, the second threaded portion 56 is inserted in a screw hole made in a faucet or engaged with a nut connected to an end of a hose.

Referring to FIGS. 6 through 8, a threaded section (not numbered) of the chuck 7 is inserted in the screw hole 24 of the shell 2. Thus, the chuck 7 is connected to the hose through the joint.

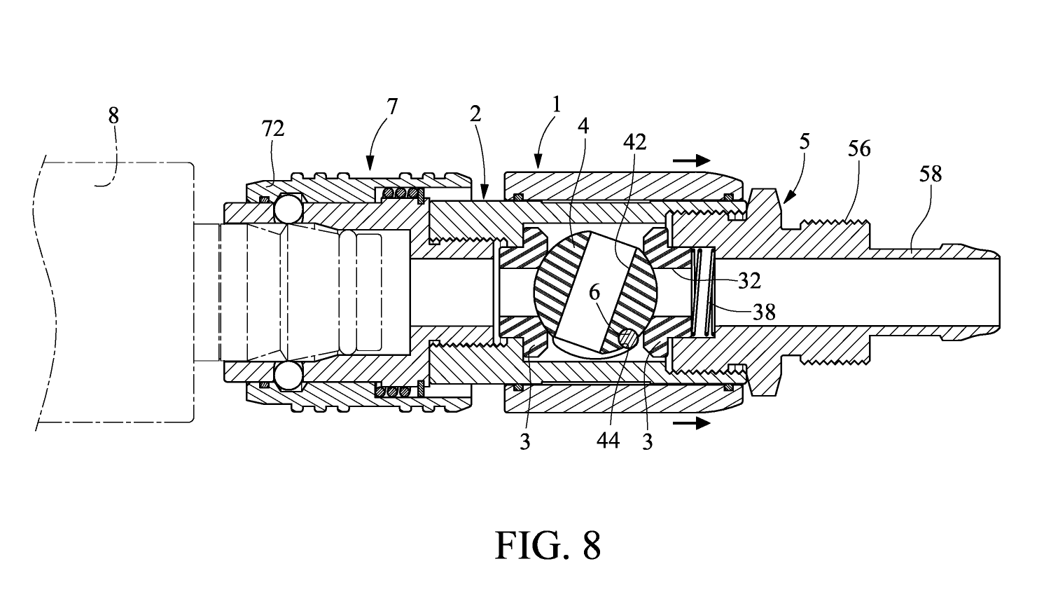

Referring to FIG. 8, the sliding collar 1 is operable to move the valve 4 to the closing position wherein water is not allowed to leave the hose through the joint 1. A sprinkler head or nozzle 8 is connected to the chuck 7 by operating the switching collar 72.

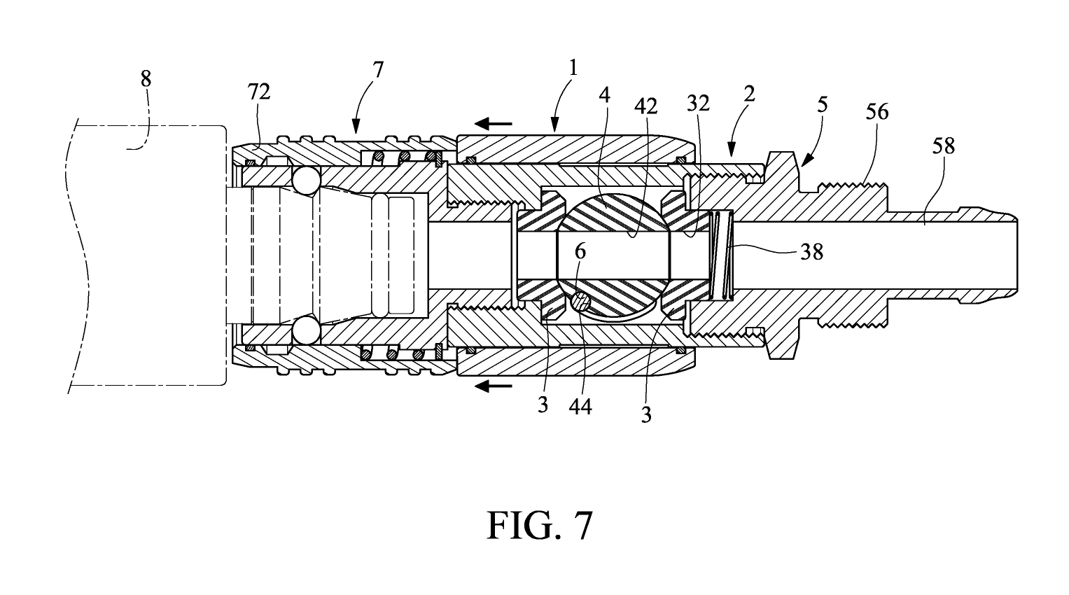

Referring to FIG. 7, the sliding collar 1 is operable to move the valve 4 to the opening position after the sprinkler head or nozzle 8 is connected to the chuck 7 by operating the switching collar 72. Now, water is allowed to leave the hose through the joint 1.

To replace the sprinkler head or nozzle 8 with another similar device, the sliding collar 1 is operable to move the valve 4 to the closing position again so that water is not allowed to leave the hose through the joint 1. The sprinkler head or nozzle 8 is disconnected from the chuck 7 by operating the switching collar 72, and the other device is connected to the chuck 7 by operating the switching collar 72. During the replacement, no water is allowed to leave the hose through the joint 1.

To move the chuck 7 to the releasing position, the switching collar 72 is moved toward the sliding collar 1. However, such movement of the switching collar 72 is hindered by the sliding collar 1 in the opening position (FIG. 7). That is, it is difficult to move the switch 72 to move the chuck 7 to the releasing position to remove the sprinkler head or nozzle 8. Water could not leak from the hose through the joint and the chuck 7.

There is a gap between the switching collar 72 and the sliding collar 1 when the sliding collar 1 is in the closing position (FIG. 8). Now, the switching collar 72 is easily movable toward the sliding collar 1 to move the chuck 7 to the releasing position, without being interrupted by the sliding collar 1.

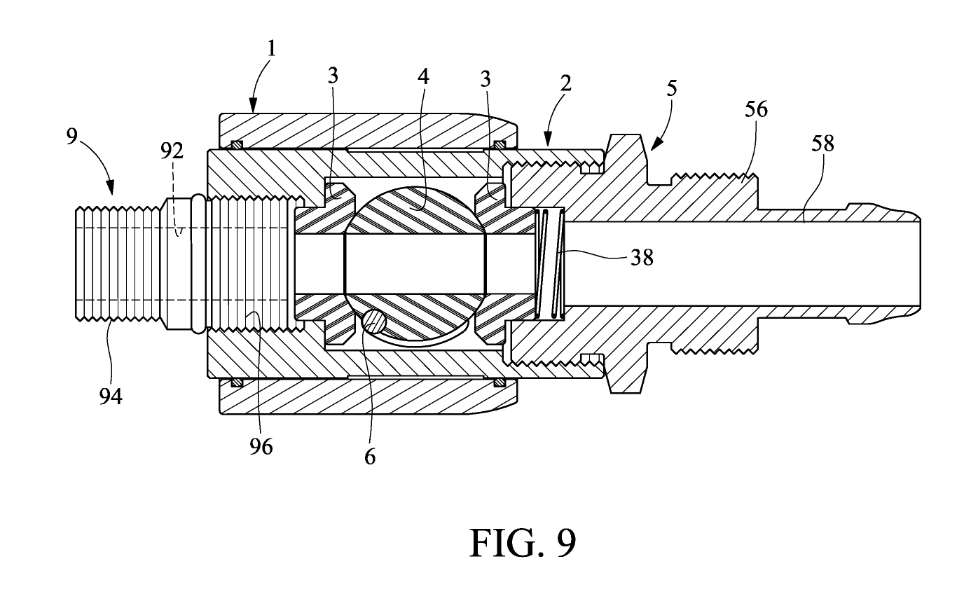

Referring to FIGS. 6 and 9, the threaded section 96 of the connective tube 9 is inserted in the screw hole 24 of the shell 2. Thus, the tunnel 92 of the connective tube 9 is in communication with the tunnel 22 of the shell 2. The threaded section 94 of the connective tube 9 is inserted in a screw hole (not shown) made in the sprinkler head or nozzle 8.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A joint comprising:
a sliding collar (1) comprising a tunnel (12) and two apertures (14) in communication with the tunnel (12);
a shell (2) extending throughout the tunnel (12) and comprising a space (22), a screw hole (26) in communication with the space (22), and two slots (28) in communication with the space (22);
two sealing rings (3) inserted in the space (22), with each of the sealing rings (3) comprising an opening (32) in communication with the space (22);
a valve (4) located between the sealing rings (3), and formed with a channel (42) extending throughout the valve (4) and a tunnel (44) extending throughout the valve (4);
a connector (5) comprising a primary threaded portion (54) inserted in the screw hole (26) and a channel (52) in communication with the space (22); and
a rod (6) inserted in the apertures (14), the slots (28) and the tunnel (44) to connect the sliding collar (1) to the valve (4) so that the sliding collar (1) is operable to move the valve (4) via the rod (6) between an opening position where the channel (42) is in communication with the openings (32) and a closing position where the channel (42) is blocked from the openings (32).

2. The joint according to claim 1, wherein the connector (5) further comprises an insert (58) adapted for insertion in a hose.

3. The joint according to claim 2, wherein the insert (58) extends opposite to the primary threaded portion (54).

4. The joint according to claim 3, wherein the connector (5) further comprises a secondary threaded portion (56) formed between the insert (58) and the primary threaded portion (54).

5. The joint according to claim 1, wherein each of the sealing rings (3) further comprises a concave face (36) in contact with the valve (4).

6. The joint according to claim 1, further comprising a spring (38) compressed between the connector (5) and one of the sealing rings (3) to keep the sealing rings (3) in contact with the valve (4).

7. The joint according to claim 1, wherein each of the slots (28) extends along an arc.
